(19) United States
(12) Patent Application Publication
(10) Pub. No.: US 2002/0083316 A1
(43) Pub. Date: Jun. 27, 2002

(54) Boot procedure for optical tranceiver nodes in a free-space optical communication network

(76) Inventors: Scott Platenberg, Encinitas, CA (US); Glenn Hoiseth, Temecula, CA (US); Tom McMillan, San Diego, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/935,387

(22) Filed: Aug. 22, 2001

Related U.S. Application Data
(60) Provisional application No. 60/240,265, filed on Oct. 13, 2000.

(51) Int. Cl. G06F 15/177; G06F 9/24; G06F 9/00

(52) U.S. Cl. 713/2

(57) ABSTRACT

A system and method of loading a system image onto an optical node capable of routing wireless communications data so as to provide operational capabilities to the node is disclosed. To facilitate maintaining robust connections among the nodes within a communications network and to maximize recovery from failures, several versions of the system image are stored on different locations within the communications network. A version of the system image is stored in a network server located anywhere in the communication network. This version of the system image can be retrieved using the established communication link or using various file transfer protocols via various network interfaces. Moreover, additional versions of the system image can be stored locally at the node. In the event of a node failure or upon a restart of the node, the system image can be retrieved from any of the different locations and in any specified order.

Additionally, system image load attempt failure detection method is disclosed wherein the factors such as ‘time since last boot attempt’ and ‘number of load attempts’ are incorporated to maximize the likelihood of successful system image load.

### RELATED APPLICATION

This non-provisional application claims a benefit of priority of the provisional patent application Serial No. 60/240,265 titled “Boot Procedure for Optical Transceiver Nodes in a Free-Space Optical Communication Network”, filed Oct. 13, 2000, which is incorporated herein by reference, in its entirety.

### BACKGROUND OF THE INVENTION

1. Field of the Invention

The invention relates generally to communication systems, and to a system and method for providing boot procedure for optical transceiver nodes in a free-space optical communication network.

2. Description of the Related Art

Over the last several years there has been tremendous growth in the deployment of fiber-optic facilities by telecommunications carriers such as Regional Bell Operating Companies (RBOCs), cable carriers, and Competitive Local Exchange Carriers (CLECs). Deployment of these facilities along with the introduction of technologies such as OC-192 has dramatically lowered the marginal cost of bandwidth on the fiber.

Thus, as a result of this development, there is extensive bandwidth and communications capability in carriers' backbone networks. However, many homes and offices do not have a practical solution to interface to these backbone networks. Consequently, direct attachment of potential customers to these backbone networks remains very expensive.

Currently, there are two practical methods for directly attaching customers to backbone networks such as optical fiber networks. These are buried or aerial fiber interconnections and microwave connections. However, both of these methods incur significant up-front costs before any revenue can be realized. In the case of buried or aerial fiber, these costs are associated with obtaining rights-of-way for the cable runs, and installing the cable by burying or hanging. In the case of a microwave system, these up front costs come not only from the cost associated with the microwave repeater equipment, but also from the costs associated with obtaining rights to the suitable portion of the spectrum. Therefore, system developers and integrators have sought long and hard to find suitable solutions to this “last mile” problem.

Wireless devices can provide a solution to some of the problem by eliminating the need to install cables. However, establishing and maintaining a robust connection with the wireless devices can be problematic. This is especially true in congested urban areas and during inclement weather conditions. Connection to/from the wireless devices can fail causing the devices to disappear from the network without the ability to re-establish connection.

Therefore, in order to maintain robust connections with the wireless devices, there is a need for the ability to detect failure of the wireless devices as well the ability to recover from the loss of communication links with the wireless devices.

### SUMMARY OF THE INVENTION

The invention is directed toward a system and method for implementing a communication capability that allows one or more users at one or more user facilities to communicate with a communications network. For example, users are able to communicate on one or more backbone networks supported by a common carrier or other service provider. A multi-node communication network is provided that interfaces a plurality of buildings, houses, complexes, or other facilities to a service provider's backbone network. The nodes of the network can be provided as wireless nodes with optical transceivers, for example, so that the network links can be implemented as optical communication links. As such, the several buildings integrated by the network can be included in the network without the need to do cabling or otherwise physically connect the facilities. Additionally, the use of optical transceivers avoids the need to be concerned with wireless RF constraints such as bandwidth, interference, FCC approval and restrictions, and other concerns typically associated with RF communication.

A method of loading a system image onto an optical node capable of routing wireless communications data is disclosed also. The method comprises loading a network image from a network boot server as a system image, loading a main image from a file system FLASH as the system image if loading the network image from the network boot server is unsuccessful; and loading a safety image from the file system FLASH as the system image if loading the main image is unsuccessful.

A method of loading a system image onto an optical node wherein the order of loading the system image is changed is also disclosed.

Additionally, a system for loading a system image onto an optical node capable of routing wireless communications data over air space is disclosed. The system comprises a plurality of node heads within the optical node, a node base within the optical node, a network server, a plurality of network connections, and an auxiliary channel to provide an auxiliary communication channel with the optical node. The node base further comprises a processor and various memory blocks including a boot memory block, a local memory block, a real-time clock memory block, and a system memory block. The system image can be retrieved from a plurality of locations including the local memory block and the network server.

### BRIEF DESCRIPTION OF THE DRAWINGS

These and other features will now be described with reference to the drawings summarized below.

FIG. 1 is a diagram illustrating an example communication network.

FIG. 2 is an operational flow diagram illustrating a process by which the communication network can operate.

FIG. 3 is a diagram illustrating an example implementation of a node.

FIG. 4 is a block diagram illustrating a logical breakout of components of an example node base.

FIG. 5 is a block diagram of the hardware components of the node involved with the boot procedure.

FIG. 6 is a block diagrams of the software modules involved with the boot procedure.

FIG. 7 is a data store diagram for the system image.

FIG. 8 is a flow diagram of a boot procedure to load the system image.

FIG. 9 is a flow diagram of a system image load process performed by the boot loader image.

### DETAILED DESCRIPTION

In the following description, reference is made to the accompanying drawings, which form a part hereof, and which show, by way of illustration, specific examples or processes in which the invention may be practiced. Where possible, the same reference numbers are used throughout the drawings to refer to the same or like components. In some instances, numerous specific details are set forth in order to provide a thorough understanding of the invention. The invention, however, may be practiced without the specific details or with certain alternative equivalent devices and/or components and methods to those described herein. In other instances, well-known methods and devices and/or components have not been described in detail so as not to unnecessarily obscure aspects of the invention.

Overview of the Wireless Optical Networks

A wireless optical communication network utilizes various technologies, for example, free-space optics and radio frequency (RF) or a combination of both, to provide convenient last-mile technology to extend high-bandwidth services from “on-net” buildings to “near-net” buildings.

In general, there are three different network configurations for wireless optical networks. The first is a single point-to-point link, which provides a dedicated, highcapacity link between two terminals. The second is a point-to-multi-point network that includes hub stations and customer premises equipment (CPE). This topology works by placing the hub station on a tall building. Laser signals are then transmitted in a star topology to the surrounding buildings. These buildings receive and transmit the signal to CPEs mounted on the roof or place in windows.

The third and most reliable type of network configuration is the optical mesh network. This topology is an extension of point-to-point links and best provide last mile access in dense urban areas and business campus environments. The mesh network is comprised of short, redundant links, eliminating a single point failure and ensuring carrier class reliability in inclement weather conditions including dense fog conditions.

The invention is directed toward a system and method for providing enhanced features for a communication network. The communication network can be implemented to provide high quality, high-bandwidth communication services to the home, office, or other facility. Advantageously, the communication network can be implemented to provide an interface between the numerous and diverse communication equipment in various homes, offices or other facilities and copper or fiber backbone carrier networks.

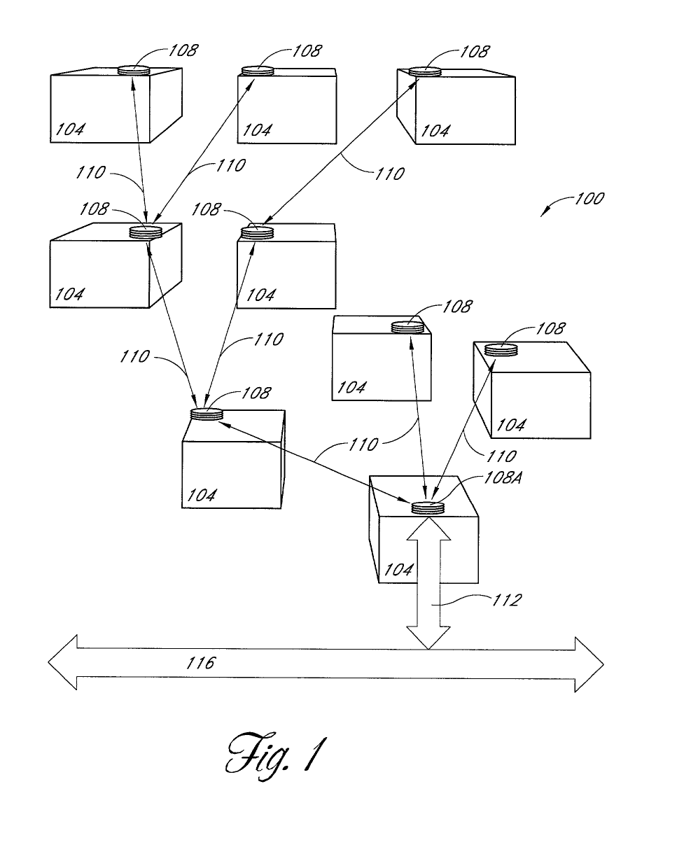

FIG. 1 is a diagram illustrating an example communication network 100. Referring now to FIG. 1, the example communication network 100 illustrated in FIG. 1 can include a plurality of nodes 108, interconnected by communication links 110. According to one example, the network nodes 108 are disposed on facilities 104. Although only one node 108 is provided per facility in the example illustrated in FIG. 1, more than one node 108 can be provided at one or more of facilities 104, depending on the communication requirements, and also, perhaps, depending on the particular facility. An example communication network 100 is described in the patent application Ser. No. 09/181,044 titled “System and Method for Improved Pointing Accuracy”, filed on Oct. 27, 1999, which is hereby incorporated by reference, in its entirety,

The facilities 104 can be buildings, towers, or other structures, premises, or locations. Advantageously, facilities 104 can, for example be homes or offices to which it is desirable to interface one or more backbone networks of one or more common carriers or service providers. The network 100 can provide the interface between the facilities and the backbone network.

The nodes 108 are interconnected with one another by optical communication links 110. In this optical communication, nodes 108 can include one or more optical transmitters and receivers to provide the communication links 110 among the plurality of nodes 108. Nodes 108 can also be implemented such that communication links 110 are RF communication links. Alternatively, the nodes 108 can be implemented with both RF and optical communication links. Although nodes 108 can be hardwired together, it is preferable that communication links 110 be wireless communication links to better facilitate interconnection of a variety of facilities.

The number of transmitters and receivers provided at a given node 108 can be varied depending on the fan-out capabilities desired at that node 108. For example, each node 108 can have four transceivers, allowing each node 108 to connect its associated facility 104 with up to four additional nodes 108 at four additional facilities 104. The provision of both a receiver and transmitter (i.e., transceiver) for each fan out of the node 108 allows bi-directional communication among nodes 108.

In examples using optics technology, transceivers at nodes 108 can be implemented using, for example, lasers or light emitting diodes (LEDs) as the optical transmitters and charge-coupled devices (CCDs), photomultiplier tubes (PMTs), photodiode detectors (PDDs) or other photodetectors as the receivers.

Although the network 100 illustrated in FIG. 1 is illustrated as a branching tree network structure, other network structures or geometries can be implemented. For example mesh network is describe in the U.S. Pat. No. 6,049,593 issued Apr. 11, 2000 to Acampora, hereby incorporated by reference in its entirety.

The network 100 can be implemented and utilized to directly connect a plurality of customers in one or more facilities 104 to a high-capacity communication network 116. For example, network 100 can be used to connect the plurality of customers to a copper or optical fiber backbone network. Advantageously, the network can therefore allow the customers to access a high data rate, high-bandwidth communication network from their home, office or other facility, regardless of the existing connection capabilities within that facility. Thus, network 100 can be implemented to avoid the need to cable a backbone network over the “last mile” to each facility 104.

To accomplish this objective, at least one of nodes 108 is designated as a root node 108A. Root node 108A includes additional functionality to interface the communication network 100 to a provider network 116 via another communication link 112. For example, provider network 116 can be a high bandwidth copper or fiber service provider or common-carrier network 116.

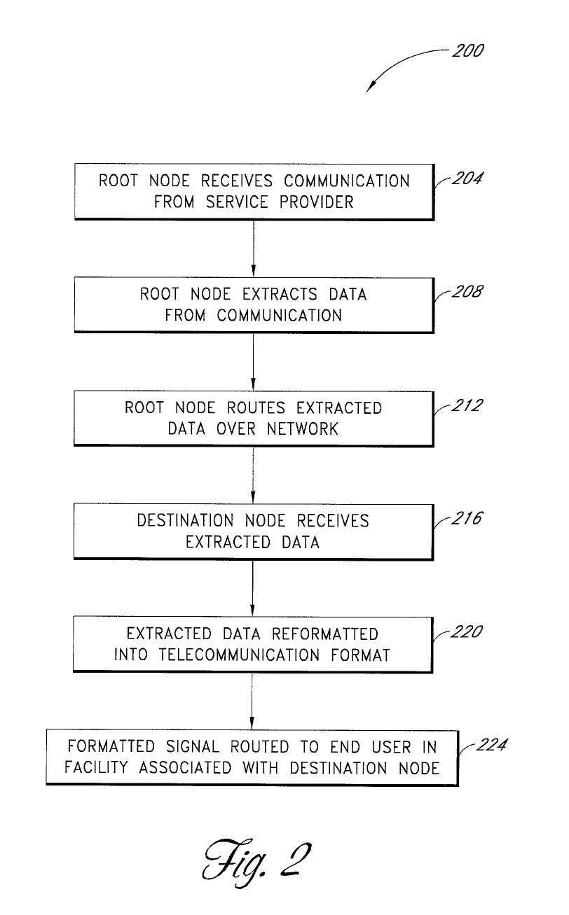

FIG. 2 is an operational flow diagram illustrating a process by which the communication network can operate. In a step 204, a root node 108A of communication network 100 receives a communication from the provider network 116. In a step 208, root node 108A accepts the communication and, if necessary or desired, reformats the communication into a format that can be transported across the network of nodes 108 and communication links 110. For example, where network 100 is a packet-switched network, root node 108A formats the communication into packets suitable for transmission across the optical communication links 110.

Root node 108A may also determine routing information such that the data can be sent to the appropriate destination node 108, also referred to as a premise node 108. Where packet data are used, the routing information can be included in the packet header of the packets being sent across network 100. In alternative network geometries, a designation of the destination node 108 may be used in place of or in addition to routing information. For example, ring geometries use destination information as an address for the packets in place of routing information.

In a step 212, root node 108A routes the reformatted data across the network 100 to the designated destination node 108. The route may be directly connected to destination node 108 or via one or more intermediate nodes 108, which are referred to as junction nodes 108 in this capacity. For example, where using packet data, the junction nodes 108 may use packet header information to route a received packet to the next node 108.

In a step 216, the destination node 108 receives the data. The received data is forwarded to the end user at the facility 104 associated with the destination node 108, This is illustrated by step 224. For example, prior to forwarding the data to the end user, the data is reformatted. Alternatively, the data is reformatted into a telecommunications format such as, for example, the original format that the data was in when it was received from provider network 116. This is illustrated by step 220.

The fact that the user is interfaced to the provider network 116 via the network of links 110 and nodes 108 is transparent to the user in this example. Communications from the user to the provider network 116 can similarly take place, but in the reverse order. Thus, network 100 can provides a two-way connection between one or more users in one or more facilities 104 with provider network 116. Although only one provider network 116 is illustrated in FIG. 1, alternatively, one or more root nodes 108A can be used to interface to more than one provider network 116.

Thus, a service provider can provide service to users in a plurality of facilities 104 by providing a signal to the root node 108A of the system. For example, nodes 108 use the Asynchronous Transfer Mode (ATM) as the data transport mechanism. Although nodes 108 can use other transport mechanisms, in this example, the service provider provide data to root node 108A as ATM cells. In this manner, root node 108A does not have to perform a format translation. Alternatively, format translation can be provided to allow flexibility.

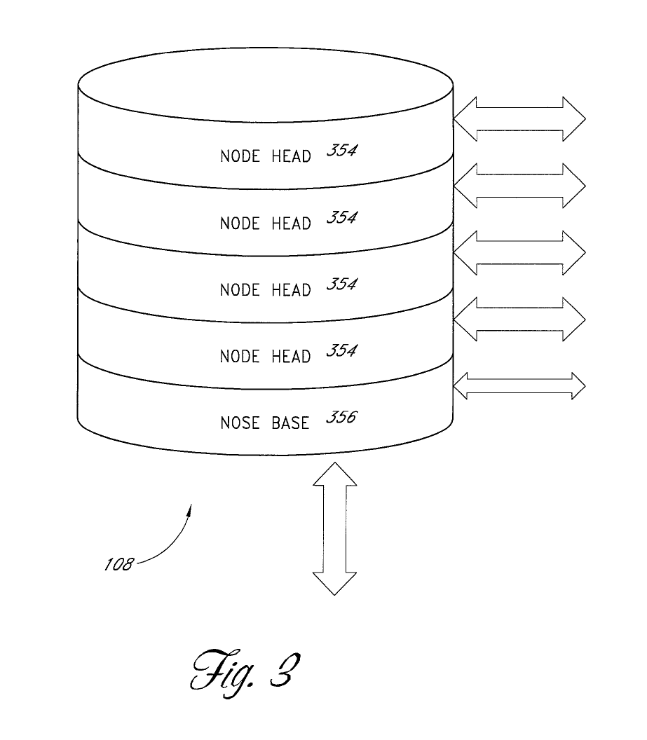

Nodes 108 are now described in more detail. FIG. 3 is a diagram illustrating an example implementation of a node 108. The example implementation of node 108 illustrated in FIG. 3 is generally cylindrical in shape and includes four node heads 354 and a node base 356. Node heads 354 can each include a transceiver to facilitate communication with one or more other nodes 108 in a network 100. For example, there is a single transceiver in each node head 354, and each node head 354 provides a communication link 110 with one other node 108 in the network 100 at a given time.

Each transceiver has both a receiver and a transmitter, providing two-way communications. Alternatively, a node head 354 has just a transmitter or just a receiver, thereby providing one-way communications. Additionally, it is possible for one or more node heads 354 to include more than one transceiver, or an additional receiver or transmitter to provide additional capabilities. As stated, the transceivers are optical transceivers, however, alternative wireless transceivers can be implemented operating at wavelengths other than optical wavelengths.

The example illustrated in FIG. 3 includes four node heads 354. Thus, in this example and where each node head has a single transceiver, node 108 so configured can communicate with up to four other nodes 108 at four separate locations. Other numbers of node head 354 can be included, depending on the fan-out capability desired for the node, 108. For example, four node heads 354, each with a two-way transceiver, can be the configuration.

Each node head 354 can include a pointing mechanism such that it can be rotated to point to a designated other node 108. For example, such pointing can be performed in both azimuth and elevation. Each node head 354 can be independently pointed to a designated node 108.

Still further, the example implementation illustrated in FIG. 3 is substantially cylindrical in shape. This facilitates pointing to other nodes in a full 360-degree circle. One advantage of this shape is that an optical communication beam is always at a substantially right angle with respect to the cylindrical housing, regardless of pointing. This helps to maximize the transmitted beam power. Note that the housing for each node head 354 could also be shaped as a portion of a cylinder in the vertical direction to allow perpendicular passage of the beam through the housing as the beam is pointed in the elevation direction. Of course, alternative shapes for the housing can be implemented as well.

Note that in one example, one or more node heads 354 can be implemented with the communications equipment to allow them to communicate with equipment other than another node 108. This equipment can be implemented using, for example, wireless RF communications or other communications techniques. Alternatively, the node heads 354 can dedicated to inter-node communications via communication links 110.

Node base 356 includes the electronics and mechanics to provide a communications interface between, for example, a network 116 and the one or more node heads 354. A communications interface to perform protocol or format conversions can be included in the node base 356 as well as mechanics to drive the pointing of one or more node heads 354.

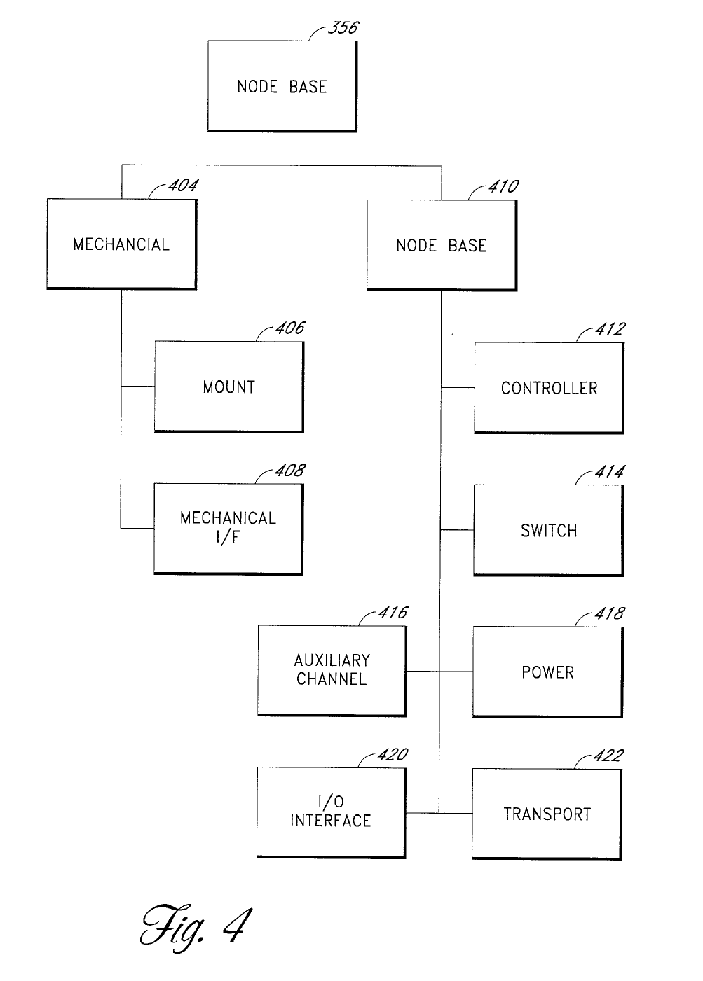

One or more node bases 356 can be included in a node 108 to provide, among other functions, control of node 108 and to interface node 108 to facility 104 or a network 116. Alternatively, these functions can be delegated among one or more of node heads 354. FIG. 4 is a block diagram illustrating a logical breakout of components of an example node base 356. This logical grouping is provided for discussion purposes only, and should not be interpreted to require a specific physical architecture for a node base 356.

Referring now to FIG. 4, node base 356 includes mechanical components 404 and electronics or electrical components 410. The mechanical aspects of node base 356 include a mount 406 to mount node base 356 to facility 104, and structure utilized to interface power 408 to the node base 356. Electronics 410 can include, in the illustrated example, a controller 412, a packet switch 414, and auxiliary channel 416, power 418, I/O interface 420, and transport interface 422. Each of these logical components is now described.

Base mount 406 provides a physical mount by which a node 108 can be mounted to the facility 104 premises. The base mount 406 can be implemented to provide at least two functions. One function that the base mount 406 can perform is that of leveling or otherwise adjusting the position or orientation of node 108. To this end, the base mount 406 can include a leveling device such as, for example, a mechanical ball joint apparatus, or other apparatus to allow leveling of the unit.

Electronics elements 410 are now described. An auxiliary channel 416 can be included among electronic elements 410 to provide communications between a node 108 and another entity separate from or in addition to communication link 110 and network 116. The communication link 110 provides in-band communication while the auxiliary channel 416 provides out-of-band communication. The auxiliary channel 416 can be implemented, for example, via ethernet, serial or infrared connections. The provision of such an auxiliary channel 416 can be provided for various purposes. One purpose would be to pass data to or from a new node 108 during installation of that node 108. Thus, before the node is interfaced to facility 104 or network 116, auxiliary channel 416 can be utilized to allow that node 108 to communicate with other entities to facilitate installation or to share data for other purposes. For example, the auxiliary channel 416 can be utilized to download the system image of the node from a network server.

Additionally, an auxiliary channel 416 can be used to provide an auxiliary communication channel with node 108 for communication during the field life of node 108. For example, the auxiliary channel 416 can be used to provide status or other signals to another entity, or to receive control signals or updates from another entity. The other entity referred to in this description is, for example, a central office or other office through which the network 100 can be controlled, monitored or adjusted. Auxiliary channel 416 can be used during installation and integration of a node 108 into network 100, or during operation of a node 108 within network 100.

Various communication formats or protocols can be used to provide the auxiliary channel 416. For example, the auxiliary channel 416 can be hard-wired such as a hard-wired telephone line. Alternatively, the auxiliary channel 416 can be provided as a wireless RF communication link such that line of sight communication is not required.

Auxiliary channel 416 may also be used to communicate with a node 108 if that node 108 has otherwise “disappeared” from the network. Thus, if the other transport channels (i.e., channels 110) of the node 108 are not functioning, auxiliary channel 416 can be used. For example, auxiliary channel 416 can be used to send communications to and receive communications from the otherwise disabled node 108. In this application, auxiliary channel 416 can send status information back to the central office, which may give technicians an indication of a problem that may exist with the node 108. Thus, if a technician is dispatched to facility 104 to repair the disabled node 108, that technician can be better prepared having this information obtained before leaving the office. The auxiliary channel 416 can be battery powered or solar powered such that it can operate even in the event of a power failure elsewhere in the node 108.

Referring still to FIG. 4, switch 414 is provisioned to accept network management commands such that it can create virtual paths. In other words, the routing tables of switch 414 are configured such that they are responsive to software-issued commands, allowing them to translate a virtual path identifier of each arriving cell to a predetermined routing. The switch 414 can provide multiple, bi-directional data paths, for example 9×9 bi-directional data paths, between the node heads 354 and the customer facility 104. Data to/from any of the node heads 354 can be routed by the switch 414 to/from any drops to the customer facility 104. FIG. 4 illustrates a drop 415 from the switch 414 to the customer facility 104. In addition, the switch 414 can include diagnostic features, including an ability to report cell loss statistics to the central office. Such statistics can be included in the data stream via communications network 116, through an auxiliary channel 416, or otherwise.

Switch 414 can be an ATM switch. ATM switches are generally well known in the art, and are therefore not discussed in more detail here. Generally speaking, the ATM switch detects an arriving cell, aligns boundaries of cells arriving on multiple input lines, inspects the virtual path identifier (VPI) to determine the routing for a cell, converts the serial stream into a word parallel format, and time multiplexes the words onto time slots on a shared bus. A routing processor provides routing translation instructions to routing tables or accepts arriving virtual path identifiers from line interfaces to provide the correct routing instruction. A plurality of routing elements can be provided for each output. The routing element inspects the routing instruction associated with each word appearing on the shared bus and delivers to its corresponding output cue only those cell segments intended for that output.

In the ATM protocol, each output cue reassembles the arriving word into ATM cells and delivers each ATM cell to the corresponding output port in serial format.

Referring to FIG. 4, I/O interfaces 420 can provide the ability to interface node base 356 to node heads 354 or other external devices. The access port can be provided at the top of the top node head 354 to provide easy access to the I/O link after the node 108 has been installed at a facility 104.

A diagnostic I/O interface can be included which provides a communication link from node base 356 to an installation fixture or to an external diagnostic device. Although any of a number of link types can be provided, an optical link is provided, in order to be able to maintain enclosure integrity. Thus, the access port for the diagnostic I/O interface is a window transparent to infrared radiation. The diagnostic I/O interface can be infrared-based, such as IrDA (Infrared Data Acquisition) or serial-port based, such as RS-232 serial port.

A data input/output section can also be provided to allow data to be exchanged between node base 356 and node heads 354. Where the node heads 354 are addressed, the data I/O interface can include a plurality of address lines that enable selection of a particular node head 354. This addressing capability is useful where the communication between node heads 354 and node base 356 are multiplexed communications. Of course, where addressing is not necessary, these address lines do not need to be provided.

The address lines can also be provided and used to allow data to be written to various components in node heads 354 such as, for example, digital potentiometers, registers, or other devices or components. Another function of the data I/O interface 420 can be to digitize signals coming from node head 354 in the analog form such that they can be interpreted by a processor in node base 356. Where address lines are used, the number of lines can be determined based on the number of devices or components being addressed.

The electronics 410 of node base 356 can also include a controller 412. The controller 412 can be a processor-based controller 412. A processor-based controller can be implemented using one or more microprocessors to provide the control and operation of node base 356. Additionally, controller 412 can control functions and operations of one or more node heads 354. Microprocessor controller 412 in this example can also include memory and interfaces to packet switch 414, auxiliary channel 416, and I/O interface 420.

One function of the controller 412 is to accept communication signals from network 116 and provide these signals to one or more node heads 354 for routing over network 100. These functions can be performed by controller 412 regardless of the data formats chosen for network 116 and network 100. However, it is as likely that controller 412 processor will be asked to perform some level of protocol conversion, as different communication protocols can often exist on network 116 and network 100.

Another function that can be accomplished by controller 412 is to receive communications from a communications link 110 and provide those communications in a telecommunications protocol acceptable by the end user in facility 104.

Boot Procedure Description

Boot procedure is the procedure by which an executable system program (“system image”) of the node is loaded onto the node. The system image provides the functional capabilities to the node. Some of the functional capabilities provided by the system image include, for example, operational, administrative, and maintenance capabilities of the node, including provisioning support so that the node can be configured to participate in the network 100.

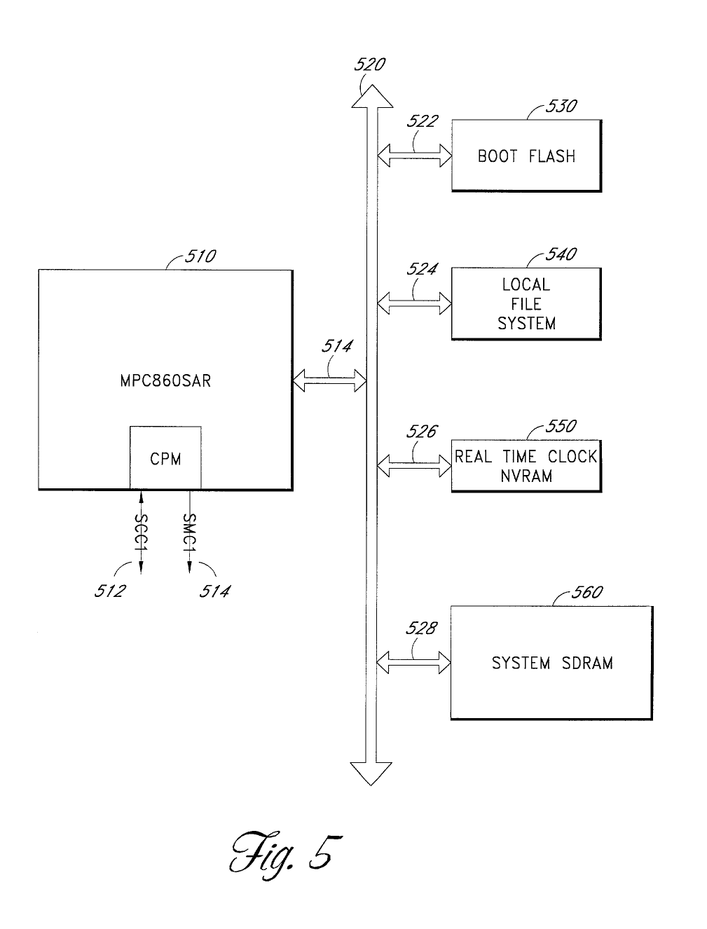

FIG. 5 is a block diagram of the hardware components of the node 108 involved with the boot procedure. The components illustrated in FIG. 5 can be a part of the controller 412 illustrated in FIG. 4. As illustrated in FIG. 5, the hardware components of the node involved with the boot procedure can comprise a processor 510, a system bus 520, a boot memory block 530, a local memory block 540, a system configuration memory block 550, and a system memory block 560. The processor 510 can further comprise a Universal Test and Operation Physical Interface for ATM (UTOPIA) component 511, an ethernet networking component 512 and a serial port component 514. Although FIG. 5 only shows one of each component, one or more processor 510, one or more memory blocks 530, 540, 550, and 560 can be used as well. The processor 510 can be implemented using a Motorola Power PC version 860 with integrated ATM Segmentation-And-Reassembly processor, MPC860SAR. As illustrated in FIG. 5, the UTOPIA component 511 provides a data path between the switch 414 and the processor 510.

The boot memory block 530 and the local memory block 540 can be implemented using non-volatile memory technology such that data is not lost when power is removed. For example, the boot memory block 530 and the local memory block 540 can be implemented using FLASH memory. FLASH memory is a type of memory similar to electrically erasable programmable read-only memory (EEPROM) wherein the non-volatile memory is programmed after its manufacture using electrical signal. However, FLASH memory, unlike the EEPROMs, is erased in blocks and therefore often used as a supplement to hard disks. Although the memory blocks 530 and 540 can be implemented using any non-volatile memory technology, the boot memory block 530 and the local memory block 540 are shown in FIG. 5 as and referred hereafter as the boot loader FLASH memory 530 and the file system FLASH 540, respectively. The file system FLASH 540 may be implemented using any number of possible hardware solutions, for example, small computer system interface (SCSI) disk, floppy disk, traditional FLASH memory, and disk-on-chip FLASH device.

Likewise, the system configuration memory block 550 can be implemented using non-volatile memory technology. For example, the system configuration memory block 550 can be implemented using a battery-backed complementary metal-oxide semiconductor random access memory (CMOS RAM). Although the system configuration memory block 550 can be implemented using any non-volatile memory, the system configuration memory block 550 is shown in FIG. 5 as and referred hereafter as the system configuration non-volatile random access memory (system configuration NVRAM) 550. The system configuration NVRAM 550 can be implemented using, for example, a Dallas DS1642 device. The system configuration NVRAM 550 also provides a real-time clock feature.

The system memory block 560 can be implemented using any memory technology, either volatile or non-volatile. For example, the system memory block 560 can be implemented using a synchronous dynamic random access memory (SDRAM). SDRAM is a form of dynamic random access memory (DRAM) that can run at higher clock speeds than the conventional DRAM by employing a bursting technique in which the DRAM predicts the address of the next memory location to be accessed. The system memory block 560 is shown in FIG. 5 as and referred hereafter as the system SDRAM 560.

Overall, the boot procedure loads the system image onto the system SDRAM 560. Thereafter, the processor 510 executes the system image that is loaded onto the system SDRAM 560.

The serial port component 514 can be used for displaying status and error messages during the boot procedure for development purposes. Additionally, the serial port component 514 can be used to interrupt the boot procedure and to designate an alternative system image.

The components listed above interface with the system bus 520 via the connections 521, 522, 524, 526, and 528 as illustrated.

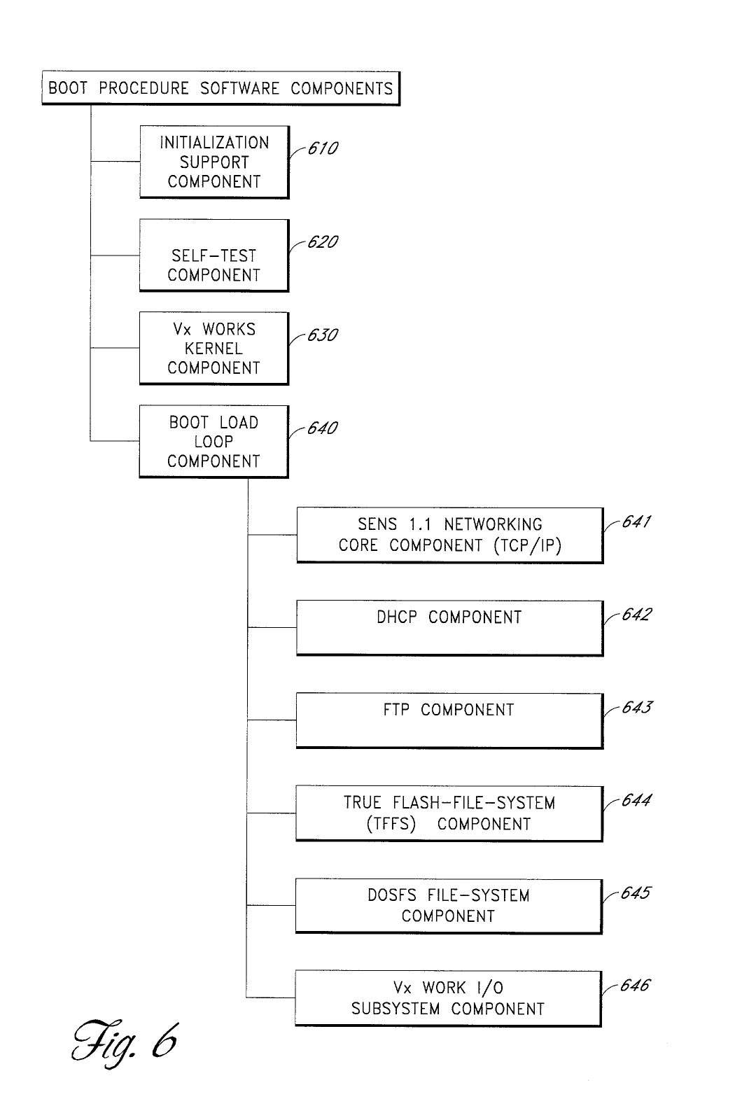

FIG. 6 is a block diagram of the software modules involved with the boot procedure. The term “module,” as used herein, means, but is not limited to, a software or hardware component, such as a field programmable gate arrays (FPGA) or application-specific integrated circuit (ASIC), which performs certain tasks. A module may advantageously be configured to reside on the addressable storage medium and configured to execute on one or more processors, for example the processor 510 in FIG. 5. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented to execute on one or more computers.

The software modules involved in the boot procedure include an initialization support module 610, a self-test module 620, a boot load module 630, and a kernel module 640. Upon power up of the node, the initialization support module 610 performs the initialization of the controller 412 while the self-test module 620 performs the self-test of the of the controller 412. The kernel module 640 provides the software infrastructure used by the boot load loop module 630 including, for example, task scheduling, memory management, file system support, and networking support. The boot load module 630 loads the appropriate system image onto the node.

As shown in FIG. 6, the kernel module 640 further comprises a networking core module 641, a file system module 644, I/O subsystem module 646, a task scheduling module 647, an exception handling module 648, and a memory management module 649. The networking core module 641 further comprises a dynamic host configuration protocol (DHCP) module 642 and a file transfer protocol (FTP) module 643. The networking core module 641 provides TCP/IP networking support so that the boot load module 630 can access network resources when attempting to load the system image over the network 100. The DHCP module 642 and the FTP module 643 are used to access the respective, i.e., DHCP and FTP, network resources. The file system module 644 provides file system abstraction so that the boot load module 630 can access the file system FLASH 540 resources using standard file I/O interfaces such as open, close, read, and write. The I/O subsystem module 646 provides an interface to any kind of device or virtual device. The task scheduling module 647 coordinates which tasks are run based on priority. The exception handling module 648 handles exceptions. The memory management module 649 is responsible for managing the memory resources and provides an interface to allocating these memory resources for use by the system. The kernel module 640 can be implemented, for example, using VxWorks kernel module.

The boot procedure by which the system image is loaded onto the node is performed by the boot load module 630. Upon power up of the node, the processor 510 starts to execute the instructions stored at a predetermined memory location of the boot loader FLASH memory 530. The processor executes the boot loader image, an executable image of the boot load module 630 residing at this location as a result of boot loader FLASH memory 530 programming. For example, the predetermined memory location can be 0x02800100 of the boot loader FLASH memory 530. Alternatively, the boot loader image can be stored elsewhere. The boot loader image contains the instructions with which to perform the load the system image process 740.

The boot procedure is invoked anytime the processor 510 restarts. The processor 510 can restart, for example, at the time of commissioning of a new node into the network 100, at the time of the system image upgrade, or at any other time the node is restarted. Each restart of the processor 510 can be commanded by either a hard reset or a soft reset. For example, a hard reset of the processor 510 can occur when the node is powered up or whenever a hardware watchdog times out triggering the processor to reset. A soft reset of the processor 510 can occur, for example, when a software task terminates abnormally or whenever a command is issued to reboot the node via the command line interface using the serial port component 514. A hard reset of the processor 510 results in clearing of a boot string in the system SDRAM 560 while a soft reset does not. The boot string is the information that is shared between the boot loader image and the system image, and is, among other things, an indication to the system image of how the system image was loaded. The boot string is stored at a predetermined address of the system SDRAM 560 and is created using the system configuration parameter stored in the system configuration NVRAM 550. In soft reset situations, the boot string is created using the system configuration parameter stored in the system configuration NVRAM 550 and the previous boot string stored in a predetermined address of the system SDRAM 560. The predetermined address of the system SDRAM 560 where the boot string is stored can be, for example, 0x4200 of the system SDRAM 560.

To facilitate maintaining robust connections among the nodes within the network 100 and to maximize recovery from node failures, several versions of the system image are stored on different locations within the network 100. For example, a network image, a main image, and a safety image denote different versions of the system image, each stored at different locations within the network 100. The network image, for example, can be stored on a network server while the main image and the safety image are stored locally in the node itself. Therefore, there can be three different locations, for example, from which the system image can be retrieved. The network server from which the network image can be retrieved can be any device accessible on the network 100. For example, the network server from which the network image can be retrieved can be another node or a computer accessible on the network 100, either directly or indirectly via other devices.

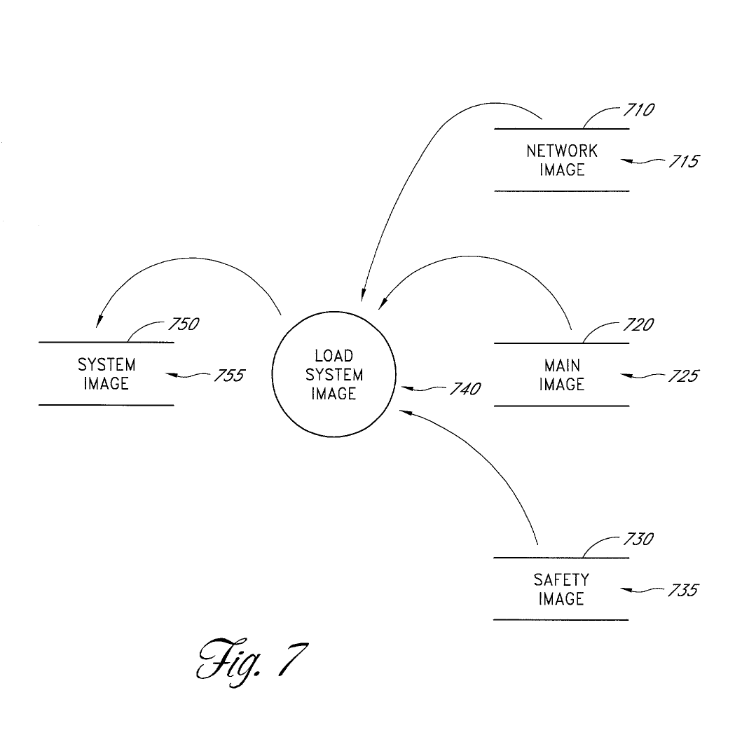

FIG. 7 is a data store diagram for the system image illustrating the concept of storing the system image at various locations within the network 100. FIG. 7 illustrates a network image 715, a main image 725, a safety image 735, and a system image 755. As shown, the network image 715 is stored at the storage location 710, the main image 725 is stored at the storage location 720, the safety image 735 is stored at the storage location 730, and the system image 755 is stored at the storage location 750. Each of the storage locations 710, 720, and 730 are locations from which a version of the system image 755 can be retrieved and loaded onto the storage location 750 of the node 108. As indicated previously, the storage location 710 to store the network image 715 can be a network server while the storage locations 720 and 730 can be locally allocated at the node base. For example, the main image 725 and the safety image 735 can be stored at the file system FLASH 540. Likewise, the storage location 750 onto which the selected image is loaded as the system image 755 can also be locally allocated within the node base of the node 108. For example, the storage 750 could be allocated within the system SDRAM 560.

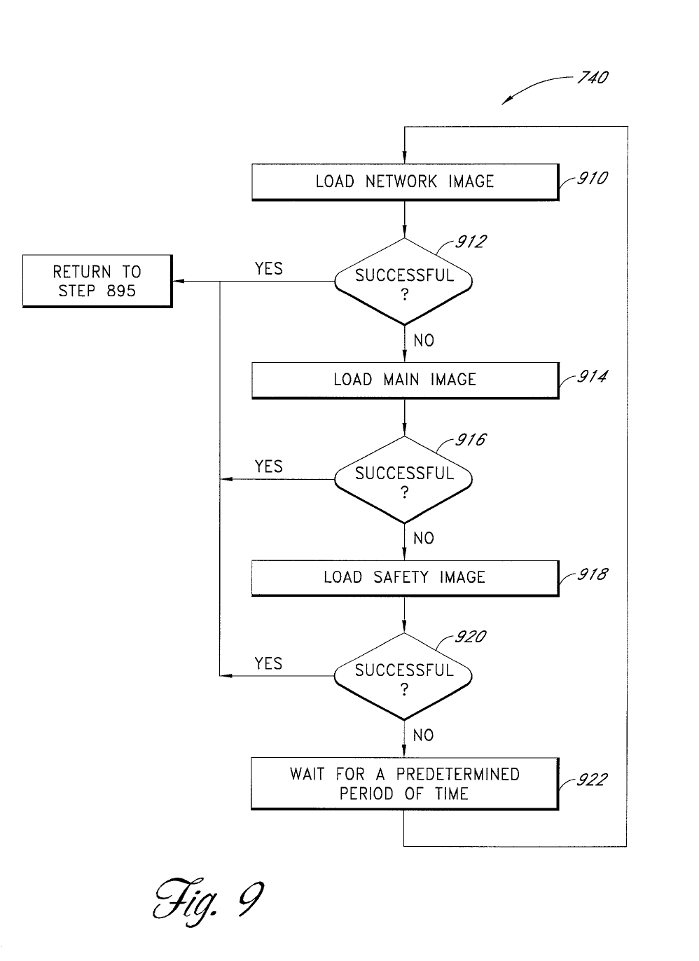

As illustrated in FIG. 7, one image among the available images, for example, the network image 715, the main image 725, and the safety image 735, is selected and loaded onto the storage location 750 as the system image 755. As highlighted above, each of these images is stored at different locations to maximize failure recovery in case of a node failure. The “Load system image” process 740 selects a particular image among the images including the network image 715, the main image 725, and the safety image 735 and loads the selected image as the system image 755 for the node via the process illustrated in FIG. 9.

During normal operation or in case of a node failure, the boot loader image, via the process 740, can search for the system image 755 at various locations, within the network including the network server and the file system FLASH 540. The order of searching performed by the boot loader image to load any particular system image located at various locations can be altered and is programmable. For example, the boot loader image can attempt to load the network image, the main image and then the safety image, in this order.

The retrieval of the network image 715 stored at the network server 710 can be accomplished via the communication link 110. The communication link 110 illustrated in FIG. 1 can be used to retrieve the network image, for example, by keeping the link 110 up during the load system image process 740. By maintaining the link 110, the system image can be received into the switch 414 and passed onto the processor 510 via the data path provided by the UTOPIA interface 511 and loaded into the system SDRAM 560. It should be realized, however, that the operation of the switch 414 is independent from that of the processor 510 and rebooting the processor 510 does not affect the operation of the switch 414.

In addition to the communication links 110, the auxiliary channel 416 can also be used as a link with which to retrieve the network image onto the node 108. By serving as an additional link to the node, the auxiliary channel maximizes the ability of the node to recover from a failure. If the communication links 110 fails for some reason, the auxiliary channel can serve as an alternate channel with which the node can recover from a failure.

Furthermore, as indicated previously, the network server storage 710 from which the network image 715 can be retrieved can be any device accessible on the network 100. For example, the network server from which the network image can be retrieved can be a node or a computer accessible on the network 100 either directly or indirectly via other devices. The IP address and the file location of the network image can be specified and stored in the system configuration NVRAM 550 of the node or learned dynamically from the network server by the boot loader image if dynamic host configuration protocol (DHCP) is enabled.

In addition to storing a version of the system image on the network server 710, other versions of the system image can be also be stored locally on the file system FLASH 540. There are two versions of the system image that are stored on the file system FLASH 540. The versions of the system image that c an b e stored on the file system FLASH can be the main image 725 and the safety image 735.

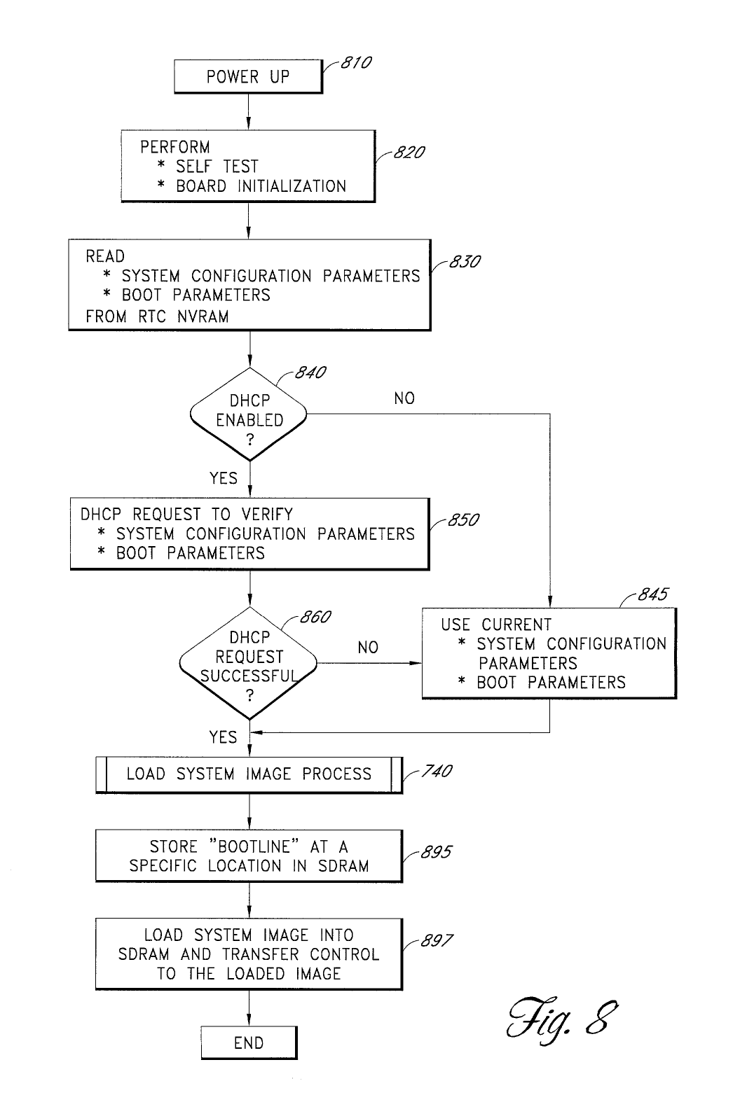

FIG. 8 is a flow diagram of an example implementation of a boot procedure to load the system image onto the node 108. The boot procedure depicted in FIG. 8 represent the instructions executed by the processor 510 under the control of the boot loader image. At a step 810, the node is powered up. Upon power up of the node, the processor 510 starts to execute the instructions stored at a predetermined memory location of the boot loader FLASH memory 530. The processor executes the boot loader image residing at this location as a result of boot loader FLASH memory 530 programming. As indicated earlier, the predetermined memory location can be 0x02800100 of the boot loader FLASH memory 530.

At a step 820, initialization and self-tests of the processor 412 are performed via the initialization support module 610 and self-test module 620, respectively. Self-tests include RAM tests which result in erasing the boot string that may be stored in the system SDRAM 560. The boot string stored in the system SDRAM 560 is erased as a consequence of the system SDRAM 560 memory test that is performed during initialization after a hard reset.

At a step 830, the system configuration parameters and boot parameters are read from the system configuration NVRAM 550. The system configuration parameters and boot parameters read are used to load and initialize the system image. Examples of parameters read from the system configuration NVRAM 550 include serial number, media access control (MAC) address, node name, IP address of the ethernet interface of the node, network server IP address, network boot file name, and ‘flags’ that allow various features, such as DHCP, to be enabled or disabled. Examples of boot parameters include the name of the host that supplies the boot file, the name of the boot file, and the IP address of the network server. The system configuration parameters are used both by the boot loader image and the system image after the system image is successfully loaded and running. The boot parameters, on the other hand, are primarily used by the boot loader image.

At a decision step 840, a determination is made whether dynamic host configuration protocol (DHCP) is enabled. If DHCP is enabled, the control flows to a step 850. The DHCP feature is either enabled or disabled by using the ‘flags’ system configuration parameter.

At the step 850, a DHCP request is made to the network server. If both the system configuration and the boot parameters are specified in the system configuration NVRAM 550, the DHCP request is made to verify the parameters. If only the system configuration parameters are specified in the system configuration NVRAM 550, the DHCP request is made to verify the system configuration parameters and to obtain the boot parameters.

At the decision step 840, if it is determined that DHCP is not enabled, the control flows to a step 845 where the currently configured system configuration parameters and boot parameters are used located in the system configuration NVRAM 550, in case of a hard reset. In case of a soft reset, the system configuration parameters and the boot parameters are located in both the system configuration NVRAM 550 and the system SDRAM 560. The currently configured system configuration parameters and boot parameters may include hard-coded default values. The hard-coded default values are those values that are stored in the boot loader image itself and are used in the absence of valid system configuration parameters and boot parameters. For example, hard-coded default values are used if the system configuration NVRAM 550 does not contain valid configuration parameters. The system configuration NVRAM 550 may not contain valid configuration parameters, for example, if the system NVRAM 550 was never configured or has experienced a hardware failure.

After making a DHCP request at the step 850, a determination is made whether the DHCP request was successful or not at a decision step 860. If the DHCP request times out, for example, no response is received from the network server within a predetermined wait period, then control flow to a step 845 where the currently configured system configuration parameters and boot parameters are used, as in the case where DHCP is not enabled.

At the decision step 860, if the DHCP request was successful, load system image process 740 is performed using the system configuration parameters and the boot parameters obtained from the network server via the DHCP request. Otherwise, the load system image process 740 is performed using the currently configured system configuration parameters and boot parameters. The load system image process 740 selects an image among the various images (i.e., network image, main image, safety image) and loads the selected image as the system image. The steps carried out by the load system image process 740 are discussed in detail in FIG. 9.

After completing the load system image process 740 illustrated in FIG. 9, the boot string is stored at a specific location in system SDRAM 560 at a step 895. As indicated previously, the boot string is a form of boot state information that is shared between the boot loader image and the system image and is stored at a predetermined address of the system SDRAM 560. The boot string is stored at a specific location in the system SDRAM 560 to enable the system image to learn how it was loaded. The system image is directly loaded into the system SDRAM 560. Alternatively, a compressed version of the system image may be temporarily stored in the system SDRAM 560 and then decompressed into the system SDRAM 560.

At a step 897, the system image is loaded into the system SDRAM 560, control is transferred to the loaded system image, and the boot procedure ends.

The boot loader image selects and retrieves a particular version of the system image depending on the load system image process 740. The load system image process 740 is specified to load the system image in a robust and simple manner while maximizing recovery from a node failure. The goal of the boot loader image during the load system image process 740 is to select and load a particular system image. The sequence by which the boot loader image attempts to load a particular system image can be manipulated to designate the next image to be loaded. Alternatively, the sequence by which the boot loader image attempts to load a particular system image can be manipulated to designate any loading sequence. For example, the load sequence can be designated to attempt to load the network image first, then the main image and then the safety image. This sequence is illustrated in FIG. 9.

Additionally, if a serial port connection 514 is available, the load sequence can be interrupted and a particular system image selected and loaded. For example, while the boot loader image is loading a main image under a prescribed loading sequence, the loading sequence can be interrupted using the serial port connection 514 to load the safety image instead. Generally, under a normal boot procedure, i.e., upon restart of a node after a hard reset wherein the processor 510 clears the boot state information in the system SDRAM 560, the image load sequence is first the network image, then the main image, and then the safety image. However, this sequence can be manipulated to prescribe any loading sequence.

FIG. 9 is flow diagram of an example load system image process 740 performed by the boot loader image. The process 740 can be used when restarting a node under normal boot procedure upon a hard reset of the node, for example. Under this example implementation of the load system image process 740, the boot loader image attempts to load the network image first, then the main image then the safety image.

Referring to FIG. 9, at a step 910, the network image load is attempted. As indicated previously, the network image can reside anywhere in the network 100. The IP address and file location of the boot file can be specified and stored in the system configuration NVRAM 550. If DHCP is enabled, the boot loader image may be able to learn the various parameters such as IP address of the boot server, the boot file name, the FTP user name, and the FTP user password dynamically from the network server. If DHCP is not enabled, the default values stored in the system configuration NVRAM 550 are used. Any number of network protocols may be used to support a network file transfer. Network file system (NFS) and file transfer protocol (FTP) are example file transfer protocols that can be used to transfer the network image from the network server onto the node. Furthermore, the auxiliary channel 416 can serve as a backup channel with which the system image from the network server can be transferred.

At a decision step 912, it is determined whether the network image load attempt was successful. The determination whether the load attempt was successful or not can be made using a variety of criteria. For example, the success criteria can be ‘time since last boot attempt’ and the ‘number of load attempts’. If the attempt to load the network image is not successful within a predetermined time interval and a predetermined number of attempts, the load attempt is deemed to have failed and the boot loader image attempts to load the next image in the designated load sequence. The boot loader image uses the parameter, ‘time since last boot attempt’, to determine if the previous boot attempt was successful or not. This prevents any configuration or boot string information that could be erroneous from interfering with the boot procedure and the subsequent boot attempts. If there are configuration or boot string information that is erroneous or poorly managed, for example, and set to indicate a good image even if the image was bad, the node may forever attempt to boot from the bad system image. Such repeated attempts could render the node useless and require an on-site repair service to recover operational capabilities of the node. The ‘time since last boot attempt’ parameter indicates what the time threshold for declaring success or failure is while the ‘number of load attempts’ parameter indicates how many failures for a given image are allowed before moving on to the next image. This is a way of preventing an intended reboot from moving to the next image within the time threshold.

Another method of determining whether the load attempt was successful can include, for example, a cyclical redundancy check (CRC) of the image desired to be loaded and the stored image. The boot loader image may initiate a soft-reset reboot of the node when it detects that the system image is corrupt via the CRC calculation. Therefore, the CRC feature can determine if the system image is valid or not and the subsequent reboot would result in a reboot within the time threshold, or a failed boot load attempt.

If the attempt to load the network image is not successful, the control flows to a step 914 to attempt to load the main image stored in the file system FLASH 540. On the other hand, if the attempt to load the network image is successful within the predetermined success criteria, the control flows to step 895 illustrated in FIG. 8.

At the step 914, an attempt to load the main image located in the file system FLASH 540 is made. At a decision step 916, it is determined whether the main image load attempt was successful. As in the previous attempt to load the network image, if the attempt to load the main image is not successful within a predetermined time interval and a predetermined number of attempts, the load attempt is deemed to have failed and the boot loader image attempts to load the next image in the designated load sequence.

If the attempt to load the main image is not successful, the control flows to a step 918 to attempt to load the safety image stored in the file system FLASH 540. On the other hand, if the attempt to load the main image is successful within the predetermined success criteria, the control flows to step 895 illustrated in FIG. 8.

At the step 918, an attempt to load the safety image from the file system FLASH 540 is made. At a decision step 920, it is determined whether the safety image load attempt was successful. As in the previous attempts to load the network image and the main image, if the attempt to load the safety image is not successful within a predetermined time interval and a predetermined number of attempts, the load attempt is deemed to have failed. In this example, the safety image is the last image in the designated load sequence. Therefore, the process 740 repeats the load sequence starting from the network image load attempt at step 910. The process 740 repeats the load sequence indefinite number of times to minimize the likelihood that the node would fail to load a system image and to maximize the likelihood that the node would be able to load a system image.

Alternatively, the boot procedure can be invoked after a soft reset of the processor 510. After a soft reset, as in the case of a hard reset, the loading sequence performed by the load system image process 740 may start from an image other than the network image. An attempt is made to load the next image in the sequence of images to be loaded. Unlike the boot procedure illustrated in FIG. 8 wherein the loading sequence starts from attempting to load the network image first, the boot loader image attempts to load the next image in the normal load sequence by detecting the previously running image. For example, if a reset of the processor 510 is issued while the main image was running as the system image, the boot loader image will attempt to load the safety image upon restart of the processor 510. Likewise, a reset while running a safety image as the system image results in an attempt to load the network image as the next image. The ‘time since last boot attempt’ and the ‘number of load attempts’ parameters that are stored in the system configuration NVRAM 550 are used to determine the next image to be loaded. When a soft reset is issued, the boot string is also used wherein the same image that was previously loaded successfully is attempted to be loaded. For example, if a soft reset is issued while running a safety image as the system image, the boot loader image will attempt to load the safety image again, if the safety image was the image that was previously loaded successfully.

If the node is first turned on, i.e., boot is a cold boot, the first image to be booted is the network image. However, if the previous boot was a network image boot and the previous boot failed, as determined by the parameters ‘time since last boot attempt’ and the ‘number of boot attempts’ in the system configuration NVRAM 550, the main image load is attempted. The network image load can be attempted once in order to minimize the delay during booting for normal boot operations. Additionally, the information stored in the system configuration NVRAM 550 to determine which image to load is not reset until a successful image load is detected or until the boot procedure has cycled through all of the image types, i.e., the safety image reaches its boot fail threshold. As a result, the first image attempted to load subsequent to a successful boot will be the image that successfully loaded previously. Until then, the information in the system configuration NVRAM 550 is not reset.

Unlike in the case of a hard reset of the processor 510, the soft reset of the processor 510 does not clear the boot state information in the system SDRAM 560. Since the soft reset of the processor 510 does not result in clearing of the boot state information in the system SDRAM 560, the boot loader image uses the boot state information stored in the system SDRAM 560 upon a soft reset.

While various examples specifying a variety of image load sequence is discussed herein, as indicated previously, the next image to be loaded can be specified to accommodate various situations.

Although the invention has been described in terms of certain examples, other examples that will be apparent to those of ordinary skill in the art, including examples which do not provide all of the features and advantages set forth herein, are also within the scope of this invention. Accordingly, the scope of the invention is defined by the claims that follow. In the claims, a portion shall include greater than none and up to the whole of a thing; encryption of a thing shall include encryption of a portion of the thing. In method claims, reference characters are used for convenience of description only, and do not indicate a particular order for performing a method.

What is claimed is:

1. A method of loading a system image onto an optical node capable of routing wireless communications data, the method comprising:
retrieving system configuration parameters and boot parameters;
loading the system image;
loading an alternate system image upon detecting any failures during loading the system image; and
storing a boot string such that the system image can learn how it was loaded.

2. A method as defined in claim 1, further comprising performing a self-test and an initialization of a controller located in a node base the optical node.

3. A method as defined in claim 1, wherein the system image is retrieved over a network connection.

4. A method as defined in claim 1, wherein the system image is retrieved over an auxiliary channel connection.

5. A method as defined in claim 1, wherein the system image is retrieved from a local memory block.

6. A method as defined in claim 1, further comprising storing and retrieving the system configuration parameters and the boot parameters from a system configuration memory block in the node base.

7. A method as defined in claim 1, further comprising retrieving and verifying the system configuration parameters and the boot parameters via a DHCP request over a network connection.

8. A method as defined in claim 1, further comprising detecting failures when a predetermined time interval and a predetermined number of load attempt are exceeded.

9. A method of loading a system image onto a wireless node in a network comprising various facilities, a plurality of nodes, a backbone network, and one or more network servers storing a system image, said node capable of routing wireless communications data and interconnected by communication links with the plurality of nodes in the network, the method comprising:
(a) loading a network image from the network server onto a system memory block as the system image for execution by a processor;
(b) loading a main image from a local memory block onto the system memory block as the system image for execution by the processor if loading the network image from the network server is unsuccessful; and
(c) loading a safety image from the local memory block onto the system memory block as the system image for execution by the processor if loading the main image is unsuccessful.

10. A method as defined in claim 9, further comprising repeating steps (a) through (c) if the loading of the safety image is unsuccessful.

11. A method as defined in claim 9, further comprising repeating steps (a) through (c) in any order.

12. A method of loading a system image onto an optical node capable of routing wireless communication data and comprising a plurality of node heads and a node base, said node base further comprising a processor, a boot memory block, a local memory block, a system configuration memory block, and a system memory block, the method comprising:
retrieving system configuration parameters and boot parameters from the system configuration memory block;
loading the system image onto the system memory block;
detecting failures during loading of the system image;
loading an alternate system image onto the system memory block upon failure of the system image load; and
storing a boot string onto the system memory block such that the system image can learn how it was loaded.

13. A method as defined in claim 12, further comprising detecting failures using a predetermined time interval factor.

14. A method as defined in claim 12, further comprising detecting failures using a predetermined number of load attempts factor.

15. A method as defined in claim 12, further comprising retrieving the system image from the network server over a communication link.

16. A method as defined in claim 12, further comprising retrieving the system image from the network server over an auxiliary channel.

17. A method as defined in claim 12, further comprising retrieving the system image from the local memory block.

18. A system for loading a system image onto a communication node capable of routing wireless communication data, the system comprising:
a plurality of node heads within the communication node wherein the node heads comprises a plurality of transceivers;
a node base coupled to said plurality of node heads and comprising a processor coupled to a boot memory block, a local memory block, a system configuration memory block, and a system memory block;
a plurality of communication links connecting the communication node to a communication mesh network comprising a plurality of communication nodes;
one or more network servers; and
an auxiliary channel coupled to the processor to provide an auxiliary communication channel
wherein the processor is configured to retrieve the system image from a plurality of locations including the local memory block and the network server and to load the system image onto the system memory block.

19. A boot load loop module for loading a system image onto a system memory block of an optical node in a communication network, the boot load loop module configured to control a processor to:
retrieve system configuration parameters and boot parameters from a system configuration memory block;
load the system image onto the system memory block;
detect failures during the system image load;
load an alternate system image onto the system memory block upon detecting failures during the system image load;
storing a boot string onto the system memory block such that the system image can learn how it was loaded.

20. A method of detecting system image load attempt failure, the method comprising:
tracking elapsed time between load attempts;
tracking total number of load attempts; and
flagging the system image as bad image if the system image fails to load within a predetermined elapsed time between load attempts and within a predetermined total number of load attempts.

21. The method as defined in claim 20, further comprising retrieving a new image to load as the system image when the system image previously attempted to load is flagged as bad image.
